(19) United States
(12) Patent Application Publication
(10) Pub. No.: US 2026/0328937 A1
(43) Pub. Date: Oct. 22, 2026

(54) MEASURING SYSTEM AND METHOD FOR PERFORMING A MEASUREMENT

(71) Applicant: MOBA Mobile Automation AG, Limburg (DE)

(72) Inventors: Mathias Lorenz, Limburg (DE); Joerg Ruppel, Limburg (DE); Yannic Urban, Limburg (DE); Laurenz Mueller, Limburg (DE)

(21) Appl. No.: 19/650,873

(22) Filed: Apr. 17, 2026

(30) Foreign Application Priority Data
Apr. 17, 2025 (EP) 25171432.5

(51) Int. Cl. G01S 15/08; A01B 79/00

(52) U.S. Cl. CPC G01S 15/08; A01B 79/005

(57) ABSTRACT

A measuring system for an agricultural machine or for an agricultural attachment apparatus of an agricultural machine, having: at least one distance sensor configured to detect a distance to a ground in a contactless manner and to output a distance signal, indicating a distance value, in dependence on the distance; and an evaluating unit configured to evaluate the distance value in order to determine a validated distance value, wherein the evaluating unit, when determining the validated distance value, only takes into account that distance values lying within a predetermined window.

### CROSS-REFERENCE TO RELATED APPLICATION

This application claims priority from European Application No. 25171432.5, which was filed on Apr. 17, 2024, and is incorporated herein by reference in its entirety.

### TECHNICAL FIELD

Embodiments of the present invention relate to a measuring system and an agricultural machine, in particular an agricultural machine having an agricultural attachment apparatus and a measuring system. Further embodiments relate to a method for performing a measurement and to a corresponding computer program.

In general, the invention is in the field of agricultural machines, in particular agricultural attachment apparatuses, such as, for example, a cultivator, a harrow, a plough, a soil tiller, a seeding or drilling machine, a cutting or mowing mechanism or the like. An embodiment of the invention relates to a distance measuring system for such an agricultural attachment apparatus.

### BACKGROUND OF THE INVENTION

Agricultural attachment apparatuses such as a cultivator, harrow, plough or soil tiller are used primarily for ground processing or soil cultivation, for example for loosening or changing soil, for incorporating crop residues or fertilizer into the soil and for producing seedbed-ready farmland. Seeding or drilling machines are used for sowing seeds, wherein the seeds fall into grooves drawn by sowing shares and are then covered with a layer of soil. With sowing combinations consisting of a ground processing device and a seeding or drilling machine, seedbed preparation and sowing can be performed in one step. Attachment apparatuses such as a cutting or mowing mechanism are required for mowing or harvesting, for example, grass, cereals or other fruits, wherein roots or stubbles remain on the surface as a crop residue.

The agricultural attachment apparatuses usually have a frame which can be coupled to a vehicle and via which the attachment apparatus can be raised and lowered and set to a specific working height or working depth and can be kept at a constant working height or working depth during the work. The vehicle can be, for example, a self-propelled agricultural working machine such as a tractor or a harvesting machine for mowing or threshing grains of cereals and seeds (combine harvester, forage harvester or the like).

Holding or guiding the attachment apparatus at a constant working height or working depth is required in modern agriculture, for example, in the case of stubble processing and seedbed preparation with the aid of a cultivator, which can be carried out in several steps with different working depths. Thus, in a first step, in the case of flat processing, volunteer cereals and organic mass are worked into the ground close to the surface. The then germinating volunteer cereals are processed again with the same cultivator at a later point in time, wherein the working depth here is approximately 10 to 15 cm. Depending on the seed and sowing method, the cultivator can also be used in a further step to work at a depth of up to 30 cm, for example. As a result of this deep processing, for example, the entire topsoil is loosened.

In the case of seeding or drilling machines, it is necessary to maintain a uniform sowing depth under virtually all conditions of use and operating speeds in order to ensure successful seed germination, for example, depending on the type of ground of soil and ground conditions and seed and type of seed.

In the case of a self-propelled combine harvester or forage harvester, it is necessary during the harvesting operation to carry out a suitable adaptation of the height and/or the transverse inclination of the cutting or mowing mechanism, for example in the case of changes in the ground profile or in the case of existing field vegetation such as grass or weeds or in the case of crops lying on the ground.

There are already some control systems for agricultural attachment apparatuses in the conventional technology. EP 3 884 747 A2 describes a control system for an agricultural attachment apparatus. The height control keeps the attachment apparatus at a corresponding height or the working tools of the attachment apparatus at a corresponding ground depth.

Furthermore, DE 10 2018 124 705 A1 describes a retrofitting kit for being attached to an agricultural attachment, which may be attached to a tractor and can be operated with the same. The agricultural attachment can be a cultivator, a short-disc harrow, a seeding machine or a rotary harrow. The retrofitting kit has a sensor for detecting the actual working depth of the agricultural apparatus. From the comparison of the actual working depth with a previously planned desired value, regulating variables for the height adjustment of the apparatus result and enable an automatic working depth guidance.

Furthermore, DE 102 14 648 A1 describes methods and measuring devices for determining the distance between an agricultural machine and the ground, wherein the agricultural machine consists of a self-propelled working machine and a front attachment and at least one sensor determines the distance between the front attachment and the surface of the field in a contactless manner.

DE 44 06 892 A1 describes a device for regulating the ground distance (or clearance) of a processing unit of an agricultural machine.

EP 0 177 024 A2 is also known, which describes a method for determining the working depth of sowing shares of drilling machines. DE 691 32 170 T2 is also to be mentioned as further conventional technology.

Furthermore, DE 10 2005 051 407 B4 is known, which describes a device for measuring the ground distance on an agricultural machine, wherein the ground distance meter is a periodically excited ultrasonic sensor.

EP 1 356 729 B1 describes a measuring device on an agricultural machine.

With regard to the application of rotary rake/hay turner, reference is made to EP 3 607 815 B1 by Kverneland, which describes an agricultural processing device (haymaker, rotary rake, loading wagon with pick-up roller or baler with pick-up roller) for use in forage harvesting and a corresponding method. With regard to the application of plant height measurement, in addition to EP 3 607 815 B1 by Kverneland, further conventional technology is known, specifically EP 2 630 856 B1. This describes a system and a method for height control of components of agricultural devices, such as, for example, spray booms and mowing bars, by means of ultrasonic sensors.

The conventional technology suffers from the disadvantage that the accuracy in the distance measurement frequently is not sufficient due to the ground quality and/or updating the height values is not high enough to ensure a dynamic regulation. Known systems available on the market are also partly very susceptible to faults due to the influence of stubbles, crop residues, etc. Therefore, there is need for an improved approach.

### SUMMARY

According to an embodiment, a measuring system, in particular for an agricultural machine or for an agricultural attachment apparatus of an agricultural machine, may have: at least one distance sensor configured to detect a distance to a ground in a contactless manner and to output one or more distance signals, each indicating a distance value, in dependence on the distance; and an evaluating unit configured to evaluate the distance value(s) in order to obtain one or more validated distance value, wherein the evaluating unit only takes into account and/or adopts that distance value(s) lying within a predetermined window as the one or more validated distance value, wherein the predetermined window is defined by an expectation value for the distance to the ground and a positive and/or negative offset so that the window defines or specifies an expectation range.

Another embodiment may have an agricultural machine, in particular an agricultural machine having an agricultural attachment apparatus, such as, for example, a cultivator, a harrow, a plough, a soil tiller, a seeding or drilling machine, a harvesting machine, a rotary rake or a hay turner, a cutting or mowing mechanism, having a measuring system according to the invention as mentioned above.

According to another embodiment, a method for performing a measurement using a measuring system for an agricultural machine or an agricultural attachment apparatus, wherein the measuring system has at least one distance sensor configured to detect a distance to a ground in a contactless manner and to output one or more distance signals, each indicating a distance value, in dependence on the distance, may have the step of: evaluating the distance value(s) in order to obtain one or more validated distance value, wherein, when determining the validated distance value, only that distance value(s) lying within a predetermined window are taken into account and/or adopted, wherein the predetermined window is defined by an expectation value for the distance to the ground and a positive and/or negative offset so that the window defines or specifies an expectation range.

Another embodiment may have a non-transitory digital computer-readable medium having stored thereon a computer program for performing a method for performing a measurement using a measuring system for an agricultural machine or an agricultural attachment apparatus, wherein the measuring system has at least one distance sensor configured to detect a distance to a ground in a contactless manner and to output one or more distance signals, each indicating a distance value, in dependence on the distance, having the step of: evaluating the distance value(s) in order to obtain one or more validated distance value, wherein, when determining the validated distance value, only that distance value(s) lying within a predetermined window are taken into account and/or adopted, wherein the predetermined window is defined by an expectation value for the distance to the ground and a positive and/or negative offset so that the window defines or specifies an expectation range, when the computer program is run by a computer.

Embodiments of the present invention provide a measuring system for an agricultural machine or an agricultural attachment apparatus of an agricultural machine. The measuring system comprises at least one distance sensor and an evaluating unit. The distance sensor is configured to detect a distance to a ground in a contactless manner, e.g., by ultrasound, and to output one or more distance signals, each indicating a distance value, in dependence on the (detected) distance. The evaluating unit is configured to evaluate the distance value or the distance values in order to determine a validated distance value. However, when determining the validated distance value, the evaluating unit only takes into account that distance value(s) lying within a predetermined window.

The window symbolizes the horizon of expectation, for example, in which the distance varies, which may also be referred to as an expectation range. According to embodiments, the predetermined window may be defined by an offset or an offset with an expectation value for the distance value.

Embodiments of the present invention are thus based on the finding that the different conditions in the sense of changes in the ground profile, different ground conditions, such as, e.g., dry or wet ground, heterogeneous vegetation or general vegetation density, field vegetation, etc., have a considerable influence on the determined distance values. In practice, the processing height or depth often varies due to the stated conditions, which results, for example, in an inhomogeneous processing structure of the ground or a corresponding loss of harvest. Because a window with a certain expectation value is defined in which the values are considered to be validated, significantly deviating values, e.g., due to measurements with respect to the vegetation instead of the ground, can thus be masked out. Thus, it is advantageously possible to reliably and accurately detect distance measurements or height measurements in a field or stubble field, even with dense ground vegetation or heavy weed vegetation. In contrast to the conventional technology, it is also not necessary to take an average value over a long period of time or several positions by strong smoothing or averaging, which then also prevents a reduction in the degree of detail accuracy from occurring.

According to embodiments, it is possible, for example using a controller, based on the validated distance values, to control and/or to keep constant a height and/or depth of an agricultural attachment apparatus of the agricultural machine. Thus, the exact height or depth (for example, 5, 10 or 30 cm) of the agricultural attachment apparatus is guided or kept during the respective work (cultivating, ploughing, sowing, harvesting, etc.) without the driver of the towing vehicle or the harvesting machine having to intervene. Due to maintaining the high degree of detail explained above, a good reaction speed in the ground distance measurement is possible. Thus, it is to be concluded in summary that high precision of the measurement accuracy with a sufficiently short reaction time under the conditions mentioned is achieved by the measurement system described.

In other words, an embodiment provides a distance measuring system for an agricultural attachment apparatus, comprising:
a distance sensor operating in a contactless manner, in particular an ultrasonic distance sensor, which emits measuring signals and receives the (echo) signals reflected from the ground or the vegetation, stubbles, etc., and
an evaluating unit, which evaluates the received (echo) signals of the distance sensor, calculates a ground distance measuring signal and outputs this signal via an interface.

According to embodiments, the core of this measuring system is signal evaluation adapted to the problem described above, wherein a reliable ground distance measuring signal determined with high measurement accuracy is advantageously provided to subsequent height or depth regulation so that the attachment apparatus is kept or guided at a predetermined target height/target depth during the work, in particular under the stated conditions.

According to a first variation of the signal evaluation, according to embodiments, the correct signal is selected from all the received (echo) signals, i.e. only that signal lying “furthest up” in a predefined target window, i.e. has the highest or greatest distance value. Then, it can then be assumed with high probability that this (echo) signal was reflected from the ground and not from the vegetation (stalk, plant, weed, etc.).

According to a second variation of the signal evaluation, according to embodiments, that signal is selected from all the received (echo) signals which “comes closest” to the most recently determined measuring value, i.e. has that distance value which is very close to or is equal to the previously determined distance value. In other words, this means that, according to embodiments, the evaluating unit, which receives several distance values (e.g. from (temporally) previous measurements or from the same measurement), discards distance values outside the predetermined window and/or (instead) uses that distance values as validated distance values which exhibit a minimum difference with respect to a previously determined distance value. Thus, it can advantageously be ensured that a continuous signal without any gaps in the signal profile is obtained.

As already explained above, according to embodiments, the predetermined window may thus be defined by a kind of offset. The offset may have a positive or negative offset component. According to embodiments, the offset may also be asymmetrical, i.e. thus amount to between −3 and +5 cm or between −4 and +10 cm, for example. According to embodiments, the size of the expectation range may correspond to between 1 and 10% or between 1 and 20% or between 1 and 30% or between 5 and 30% of the attaching height of the distance sensor. According to embodiments, the expectation range differs from an expectation value by the corresponding range of variation or the corresponding offset, which in turn is dependent on the currently to be processed soil type of the ground and the vegetation of the ground. Thus, according to embodiments, the predetermined window or the offset may be defined in dependence on a presetting and/or in dependence on a soil type of the ground and/or in dependence on a vegetation of the ground. Thus, it is advantageously possible to apply the measurement system to different grounds or, generally speaking, to adapt it to the current environmental conditions.

According to embodiments, the expectation value by which the offset varies may be defined by an initial reference value and/or a reference measurement. If the agricultural attachment apparatus is not engaged with the ground to be processed, the expectation value initially corresponds to the attaching height. If the expectation value is determined during operation, the expectation value is defined by the initial reference value and/or the attaching height and/or the initial reference measurement minus an engagement depth of the agricultural attachment apparatus or a determined/set engagement depth for the agricultural attachment apparatus. Thus, it is advantageously possible for a dynamic adaptation of the expectation value to take place.

According to embodiments, the attaching height of the sensor on the attachment apparatus and the measured distance to the ground during ground processing are different in an attachment apparatus such as cultivator, plough, seeding and drilling machine, specifically from the point in time when the ground processing device is introduced into the ground or engaged with the ground to be processed. Therefore, the predefined engagement depth is subtracted from the initial attaching height of the sensor in order to obtain the distance value actually to be regulated (ground distance value). Regulating the engagement depth could be started or triggered if, for example, the first (echo) signal represents a distance value lying in the target window. Optionally, a height signal of the three-point linkage, on which the attachment apparatus is mounted on the tractor, could also be used. This height signal (position of the three-point linkage) is also provided via a signal socket mentioned further below or via an interface mentioned further below, such as, for example, ISOBUS. Regulating the engagement depth would be started in this case if the three-point linkage was lowered to or below a predefined value.

It is to be noted at this point that, for example, the attaching height of the sensor corresponds to the distance between the sensor and the ground on which the attachment apparatus stands when it is not engaged with the ground to be processed (for example, the tip of a cultivator tine).

Based on these features, the following measuring method results according to embodiments:
1. defining target windows in the evaluating unit;
2. sensor sending an ultrasonic measuring signal in the direction of the ground and performing a reference measurement;
3. sensor receiving (echo) signals reflected from the ground and/or vegetation;
4. corresponding distance measuring values being calculated from all the received (echo) signals and the reference measurement;
5. only that distance measuring values lying in the target window are taken into account for calculating a ground distance measuring signal;
6. that signal lying “furthest up” in the target window (i.e. has the highest or greatest distance value) or which “comes closest” to the most recently determined measuring value (i.e. has that distance value which is very close or is equal to the previously determined distance value) is considered to be a valid ground distance measuring signal;
7. outputting the ground distance measuring signal via an interface;
8. the next measurement starts at step 2.

For step 1, defining target windows: The target window results from the mounting height of the sensor, i.e. the distance between the sensor and the ground, and a predefined offset range. The offset range may be a range of +/−5 cm to +/−10 cm, +/−7 cm would be optimal. Thus, the target window would be in a range of 73 cm to 87 cm with a sensor attaching height of, for example, 80 cm and a predefined offset range of +/−7 cm. In addition to a symmetrical offset range, an asymmetrical range, for example +7 cm and −5 cm, is also conceivable.

For step 3, reflected (echo) signals: practical tests have shown that, depending on the ground condition and vegetation or vegetation density, between one and up to four (echo) signals are received. If, for example, little to no vegetation at all is present, only one or two (echo) signals are reflected from the ground to be measured or the vegetation. As the vegetation density increases, the number of (echo) signals usually also increases.

For step 5: if none of the measured (calculated) distance measuring values lies in the target window, the measurement is discarded and a new measurement (step 2) is started. This case can occur if, for example, the vegetation is so dense that no ground is visible (for example in the case of grass or grassland, in which the stalks completely cover the ground). Missing measuring values or discarded measuring values can be replaced by interpolated measuring values if a path or time limit of successive measuring values has not been exceeded. The path or time limit can be, for example, a distance covered or a specific period of time, for example 5 meters or 5 seconds. These values are only exemplary, i.e. the values can also be greater or smaller.

According to embodiments, the evaluating unit is configured to discard distance values outside the predetermined window. This advantageously has the effect that these distance values, which are measured, for example, with respect to vegetation, are not included in the calculation, irrespective of whether averaging is performed or not. According to further embodiments, the evaluating unit is configured to determine the validated distance value based on a previously determined validated distance value (e.g. associated with a previous position) if all distance values lie outside the predetermined window. Thus, if no validated distance value can be determined based on the current measurement, a previously determined validated distance value can advantageously be used.

The background for this embodiment is that, according to further embodiments, a continuous measurement of the distance value takes place at several successive positions. The evaluating unit is configured to perform the determination over several distance signals and distance values associated with different positions and/or different points in time. According to embodiments, averaging can be used or a moving average can be calculated. In this respect, by such average filtering, smaller outliers are taken into account less than the large number of measured distance values. According to further embodiments, it would advantageously also be conceivable for the average filtering to be performed or a moving average to be calculated over several distance values within the window associated with different positions and/or different points in time. This has the advantage that, although varying signals within the window are thus taken into account when averaging, measurements with respect to vegetation or the like are not included in the measurement and averaging. According to embodiments, further means for signal processing are provided in the evaluating device. These may be, for example:
average value filters such as moving-average filters. In this filter, a window with a fixed width is shifted over the measuring value data lying in the target window and a new data point is calculated from the internal values. An average can also be taken over time or the distance covered, wherein the distance covered can be determined or calculated either via satellite-assisted positioning (GNSS/GPS) - some GPS receivers output a speed signal - or via a so-called signal socket on the tractor. Path information can also be provided via an interface described further below, such as, for example, ISOBUS. Modern tractors have a signal socket, which outputs impulses from which the speed can then be calculated. The distance covered can be determined via this speed information. In addition to averaging measuring value data, such a signal filter can also eliminate by calculation measuring value outliers. Support values can also be determined and used if measuring values are missing.
evaluating the amplitudes of the (echo) signals.

For the sake of completeness, it is to be pointed out that typically several measurements are performed at several successive positions or corresponding points in time in the direction of travel, which constitutes the basis for averaging or the continuous determination of the distance.

According to embodiments, the distance sensor is an ultrasonic sensor. According to embodiments, the distance sensor is configured to receive echo signals, which are reflected from the ground and/or a vegetation of the ground by an emitted measuring signal. This means that, according to embodiments, the distance sensor operating in a contactless manner advantageously comprises an ultrasonic sensor serving as a transceiver element and an evaluating unit, connected to the transceiver element, for determining distance values of the sensor to one or more objects, such as, for example, ground and/or vegetation. The transceiver element cyclically changes from a transmission mode to a reception mode, i.e. the ultrasonic sensor is alternately provided with a transmission signal by the evaluating unit for distance measurement or receives one or more signals reflected from the objects (so-called (echo) signals). The evaluating unit determines distance values between the sensor and the objects on the basis of object echo propagation times of the ultrasound from the sensor to the objects and from the objects back to the sensor. Such distance sensors are sufficiently known from the conventional technology.

According to embodiments, the distance sensor is configured to perform a reference measurement for compensating temperature influences, air pressure influences, air humidity influences and/or generally for calibration. The background is:
In order to compensate propagation time fluctuations of the ultrasonic signals due to changing environmental conditions such as, for example, temperature, air pressure, air humidity and the like according to embodiments, it is furthermore known from the conventional technology for the distance sensor to have a further ultrasonic transceiver element (reference sensor) which is also connected to the evaluating unit and measures a defined and non-changing distance to a fixed reference. Such a reference may be, for example, a fixed plate arranged on the distance sensor or a reference bracket relative to which the reference sensor measures. With the aid of this reference measurement, the influence of the environmental conditions on the distance measurement to the object can be derived and compensated. This means that the evaluating unit calculates one or more correspondingly compensated distance measuring signals from the object echo propagation time measurements between the sensor and the objects and from the propagation time measurement between the reference sensor and the reference. Examples of such distance sensors with such a reference measurement are the Sonic Ski sensor or the CSMT or CSMS sensor of the applicant.

The driver or operator can set or change the attaching height of the sensor and the respective engaging depth via a display and operating unit which is connected to the sensor via the interface (if it is embodied as a digital communication interface according to an embodiment, for example ISOBUS). In this context, a so-called teach-in functionality would be conceivable, i.e. attaching height and engaging depth can be determined and stored automatically by pressing a button. Further parameters relating to the distance measuring system, such as, for example, a sampling rate (measuring period) or transmission or reception parameters of the sensor, for example a transmission power or a receiver sensitivity of the sensor, or the type of vegetation on the ground to be processed (for example stubbles of rape, maize, wheat, sunflowers etc. or grassland), can also be set or changed via this display and operating unit. The sampling rate (measuring period) of the sensor is usually approximately 20 ms, wherein the value for the sampling rate can also be greater or smaller.

According to embodiments, it would be conceivable for the evaluating unit to be configured to vary a sampling rate and/or a measuring period for the distance value in dependence on a type of the ground and/or a vegetation of the ground and/or a presetting and/or a travel speed of the machine. According to further embodiments, the evaluating unit is configured to adapt a filter setting in dependence on a type of the ground and/or a vegetation of the ground and/or a presetting and/or a travel speed of the machine. According to further embodiments, the evaluating unit is configured to adapt transmission or reception parameters of the distance sensor, i.e. a transmission power or a receiver sensitivity of the ultrasonic sensor for the measurement of the distance value, in dependence on a type of the ground and/or a vegetation of the ground and/or a presetting. According to further embodiments, the evaluating unit is configured to activate or deactivate a mode for evaluating the amplitude of the distance signal in dependence on a type of the ground and/or vegetation of the ground and/or presetting. For this purpose, according to embodiments, the evaluating unit can be connected to a man-machine interface, via which the type of the ground and/or the vegetation of the ground and/or the presetting can be defined.

It is advantageous to change, i.e. to reduce or to increase, the transmission power of the (ultrasonic) sensor under specific circumstances. Thus, for example, the transmission power of the sensor can be reduced in the case of grounds with little vegetation or low vegetation density, since a distance from the ground can be detected quite well. In the case of a high vegetation density, on the other hand, it can be advantageous to increase the transmission power of the sensor in order to be able to detect at least one (echo) signal, which maps the distance from the ground. Due to the high vegetation density, many (echo) signals received by the sensor are reflected from the vegetation, and not from the ground.

It is also advantageous under specific circumstances to change, i.e. to reduce or to increase, a receiver sensitivity of the (ultrasonic) sensor. Thus, for example, the receiver sensitivity of the sensor can be reduced in the case of grounds with little vegetation or low vegetation density, since a distance from the ground can also be detected quite well here. In the case of a high vegetation density, on the other hand, it can be advantageous to increase the receiver sensitivity of the sensor in order to be able to detect at least one (echo) signal, which maps the distance from the ground. Here, too, due to the high vegetation density, many (echo) signals received by the sensor are reflected from the vegetation, and not from the ground.

According to an embodiment, the evaluating unit can be configured to evaluate the distance value(s) in order to determine a validated second distance value, wherein the evaluating unit, when determining the validated second distance value, only takes into account that distance value(s) lying within a predetermined window. According to an embodiment, a plant height determination is made possible by this, for example by the validated first and second distance values being subtracted from each another. The predetermined window for the first distance values is set, for example, to the expected height level of the ground, while the predetermined window for the second distance values is set to the expected height level of the plant tips. Since the height of the plant tips is unknown, the window can be set larger here according to embodiments.

In this respect, in addition to the distance measurement already described, a plant height or a height of the vegetation can also be determined with the help of the measuring system. These can be both useful plants as well as harmful plants. Determining a plant height or vegetation height can influence the working quality in an advantageous manner, since settings can be adapted to the machines depending on how high and possibly also how dense the vegetation is. Thus, it is advantageous, for example, when applying fertilizer or spraying agent, to know how large or small a plant is and how dense the plants are. This can be determined with the help of the measuring system according to the invention. Thus, it would be possible, for example, to determine a density of the plant population on the basis of a comparison of detected soil and detected plant distance signals. With the help of the detected measured values, more or less fertilization or spraying can be applied accordingly. The detected measured values can also be mapped together with position data in application maps and be used for further working processes on the field. Application maps are becoming increasingly important in today's agriculture. It is attempted to collect as much information as possible on the current area during each working step. This begins with the yield measurement during harvesting, the sowing intensity during processing, the application of fertilizer and spraying agent up to the real-time measurement of the nitrogen content in the manure.

According to embodiments, the validated distance value represents a validated first distance value, wherein the evaluating unit is configured to evaluate the distance value(s) in order to determine a validated second distance value, wherein the evaluating unit, when determining the validated second distance value, only takes into account that distance value(s) lying within a further predetermined window.

An embodiment provides a measuring system, in particular for an agricultural machine or for an agricultural attachment apparatus of an agricultural machine, comprising at least one distance sensor configured to detect a distance to a ground in a contactless manner and, depending on the distance, to output one or more distance signals, each indicating a distance value; and an evaluating unit configured to evaluate the distance value(s) in order to determine a validated first distance value. The evaluating unit, when determining the validated first distance value, only takes into account that distance value(s) lying within a predetermined window. Furthermore, the evaluating unit is configured to evaluate the distance value(s) in order to determine a validated second distance value, wherein the evaluating unit, when determining the validated second distance value, only takes into account that distance value(s) lying within a further predetermined window.

According to embodiments, the evaluating unit is configured to evaluate the distance values in order to determine, starting from several validated distance values, a validated first distance value and a validated second distance value, wherein the evaluating unit takes into account that distance value(s) representing a minimum distance as the validated second distance value, and takes into account that distance value(s) representing a maximum distance as the validated first distance value.

According to embodiments, the evaluating unit is configured to determine a plant height on the basis of the difference between the first and the second distance value. Thus, a plant height can advantageously be determined at the same time. The evaluating unit can be configured to vary a height of a tool depending on a determined plant height.

According to embodiments, the evaluating unit is configured to determine a lateral position of the first distance value relative to the second distance value. Here, according to embodiments, the evaluating unit can be configured to determine a lateral position of the agricultural machine or of the agricultural attachment apparatus on the basis of the lateral position and/or to derive a control signal for the agricultural machine or the agricultural attachment apparatus on the basis of the lateral position. For example, in the case of rectilinear or linear planting, as is typical on a field, the tool and/or the agricultural machines can thus be aligned on the basis of the planting.

According to embodiments, the distance sensor has a plurality of sensor heads arranged next to one another and/or parallel to one another. This advantageously makes it possible to determine a lateral position of a measuring point.

According to embodiments, the distance sensor is positioned above the rotating tool, in particular the tool of a rotary rake or hay turner. Since only measuring values lying within a specific measuring window are taken into account, the measuring values measured with respect to the rotating tool can be disregarded. This also applies if, for example, due to the rotation, the tool temporarily is located in a field of view of the distance sensor. According to embodiments, the evaluating unit is configured not to take into account distance values measured with respect to a rotating tool and/or not to take into account distance values obtained in a time window characterized by a synchronization signal or a sensor signal, in particular a sensor signal of a Hall sensor.

A further embodiment provides a measuring system in which a GNSS sensor and/or the speed sensor is also comprised, e.g. the distance measuring system can comprise further components such as, for example, a GPS/GNSS receiver or a communication unit (WLAN/Bluetooth/etc.) in order, for example, to determine a position of the machine and of the attachment apparatus or to exchange data relating to the measuring system with an external unit (cloud server etc.).

Alternatively, an interface for receiving position information or speed information may also be provided. Furthermore, an interface may also be provided, via which the evaluating unit receives information from the system and/or emits the distance values or validated distance values, e.g. in order to perform control of the height control or depth control.

According to embodiments, ISOBUS, for example, can be used as an interface, via which the evaluating unit provides a determined ground distance measuring signal to subsequent height or depth regulation, as is usual in the case of agricultural attachment apparatuses. ISOBUS (ISO 11783) is a standardized communication protocol which is used in agricultural and forestry machines. The protocol is based on the controller area network (CAN bus). However, other types of interfaces are also conceivable in the present invention, for example an analog 4-20 mA interface or other digital interfaces or protocols such as J1939 or the like.

A further embodiment provides a measuring system which is furthermore connected to a controller which is configured to control and/or to keep constant a height and/or a depth of an agricultural attachment apparatus of the agricultural machine based on the validated distance value. According to further embodiments, the controller may be configured to control and/or to keep constant a transverse inclination based on a validated distance value.

With regard to the distance sensors, it is to be noted that, according to an embodiment, the measuring system may have several distance sensors, in particular distance sensors arranged transversely to the direction of travel. These advantageously serve for transverse regulation. This means that, in order to hold an attachment apparatus parallel to the ground, if several distance sensors, for example, two or four sensors, are arranged on the attachment apparatus, the attachment apparatus can be held in balance, i.e., parallel to the ground, both in the direction of travel and transversely to the direction of travel.

According to embodiments, a sensor unit with several distance sensors, for example ultrasonic sensors, can be used as the distance sensor. This distance sensor known as a sonic ski makes it possible to directly compensate for fluctuations by averaging several measuring points.

According to further embodiments, the distance sensor or sensors receive information on which type of ground or interfering vegetation is expected from a system arranged on the tractor via the interface (if it is embodied as a digital communication interface, for example ISOBUS). This means that the operator can, for example, make corresponding presettings to the ground type or the ground to be processed via the above-mentioned display and operating unit, wherein these data can then be communicated to the distance sensor or sensors via the interface. On the basis of these data/settings, the calculation algorithm can be adapted in the evaluating unit of the sensor, for example, suitable parameters such as sampling rate, transmission power, receiver sensitivity or filter settings can be selected or the amplitudes of the (echo) signals can also be included in a calculation of the ground distance value. For this purpose, the display and operating unit can have predefined icons, for example, via which the operator can select whether “clean” stubbles or an increased occurrence of interfering vegetation is expected in the ground to be processed. Expressed briefly, this feature describes a reaction or an adaptation of the calculation algorithm in the sensor on the basis of an operator specification.

It is to be noted that, in some embodiments, the sampling rate and measurement period in the sensor usually remain constant and are rather not changed, wherein, however, the filter settings are adapted by the evaluating electronics.

With regard to the filter settings, for example, the window width (width of the target window) is adapted dynamically, for example when the working depth changes or depending on the ground or the vegetation. Likewise, the time window of the smoothing of the measuring values is adapted, and likewise when the working depth changes or depending on the ground or the vegetation. A so-called timeout time can also be adapted. This is the time in which the sensor cannot determine valid distance values but continues to output the last valid distance value having a status “OK” (see below). Only if no valid distance value (distance value in the window) has been measured for this timeout time, will a distance value having a different status be output. All in all, the distance value of the sensor can have the following four states: sensor value is okay (status “OK” = all conditions for calculating the distance value in the window are fulfilled). The distance value is above the window (i.e. in the case of longer distances) (status “Overrange”: the sensor averages the longest echo available in the entire measuring range. The distance value consequently is longer than the upper/longer window threshold. If the distance value is below the window (i.e. in the case of shorter distances), the status will be “Underrange”, which means that the sensor averages the longest echo available in the entire measuring range. The distance value is consequently shorter than the lower/shorter window threshold. If the sensor does not obtain any echo in the entire measuring range, after a further predetermined timeout time, a status “OutOfRange” will be shown.

In addition to the depth guidance of an attachment apparatus such as a cultivator, plough, seeding or drilling machine, a height guidance of a cutting or mowing mechanism of a self-propelled combine harvester or forage harvester is possible according to embodiments with the combination of measuring system and controller.

It is to be noted at this point that, according to embodiments, the distance sensor or the distance sensors are attached at an attaching height, which corresponds to at least twice the growth height of a vegetation of the ground. The background is that practical tests have shown that the attaching height of the sensor above the ground is to be selected as high as possible, at best significantly more than twice the growth height of interfering vegetation. Since the height of interfering vegetation is approximately half the attaching height of the sensor, so-called double or multiple echo signals could occur and make a measurement or signal evaluation when selecting the “correct” (echo) signal more difficult.

According to further embodiments, it is to be noted for the attachment that the distance sensor may advantageously be arranged on the attachment apparatus such that it measures the distance perpendicular to the ground. However, it is also conceivable for the sensor to be arranged on the attachment apparatus obliquely, for example at a predefined angle of 30° or 45° to the ground surface.

According to embodiments, the evaluating unit can either be integrated in the sensor or be embodied as a separate apparatus (separate computing unit). The advantage of an evaluating unit integrated in the sensor is that the distance measuring system can be arranged in a space-saving manner and that the user, apart from a cable connection to the tractor, does not have to attach any further components to the attachment apparatus. The advantage of a separate evaluating unit (separate apparatus) is that no application-specific parts of the distance measuring system are present in the distance sensor itself, for example a calculation algorithm specifically adapted to agricultural applications. In the event of a defect of the sensor, the latter can be exchanged easily and cost-effectively. Furthermore, in this embodiment, other sensor types can also be attached, irrespective of the subsequent application. A corresponding independence of the individual components is achieved by this.

A further embodiment provides an agricultural machine, in particular an agricultural machine having an agricultural attachment apparatus, such as, for example, a cultivator, a harrow, a plough, a soil tiller, a seeding or drilling machine, a cutting or mowing tool and a corresponding measuring system. According to an embodiment, the agricultural machine may have a controller which is configured to control and/or to keep constant a height and/or a depth of the agricultural attachment apparatus of the agricultural machine based on a validated distance value. The validated distance values represent the actual values, wherein the actual height is regulated to a corresponding set height by control signals, so that as a result the actual height (substantially) corresponds to the set height.

According to embodiments, the system can be applied when using a rotary rake or hay turner, with a height guidance of the rake prongs taking place. Thus, the distance sensor is, for example, arranged above the turntable and measurements are taken through the rotating arms.

An embodiment provides a method for performing a measurement using a corresponding measuring system, having the following steps:
evaluating the distance value in order to determine a validated distance value, wherein only that distance value(s) lying within a predetermined window are taken into account when determining the validated distance value.

According to further embodiments, the method may run on a computer. According to embodiments, a computer program product having a program code for performing the method is provided, wherein the method runs on a computer or an evaluating unit.

### BRIEF DESCRIPTION OF THE DRAWINGS

Embodiments of the present invention are explained below with reference to the appended drawings, in which:

FIG. 1a shows a schematic representation of a measuring system according to a basic embodiment;

FIG. 1b shows a schematic representation of a measuring system according to an extended embodiment;

FIG. 2 shows a schematic flow chart of a method for performing a measurement according to embodiments;

FIGS. 3a, 3b show a schematic representation of an agricultural machine having a cultivator as an application example for the measuring system according to embodiments;

FIG. 4 shows a schematic representation of an agricultural machine having a plough as an application example for the measuring system according to embodiments;

FIG. 5 shows a schematic representation of a combine harvester as a further embodiment for the measuring system according to embodiments;

FIG. 6 shows a schematic diagram for representing the distance measurements in a stubble field to explain embodiments.

FIGS. 7a, 7b are schematic representations of a measuring system for plant height measurement according to embodiments;

FIG. 7c is the combination of the measuring system with a rotating tool (e.g. rotary rake) according to further embodiments; and

FIGS. 8a-8d are schematic representations to illustrate the use of a sensor with several sensor heads, here for plant height determination and/or position determination according to further embodiments.

### DETAILED DESCRIPTION OF THE INVENTION

Before embodiments of the present invention are explained below with reference to the appended drawings, it is to be pointed out that elements and structures of equal effect are provided with equal reference numerals so that the description thereof is mutually applicable or interchangeable.

As already explained above, embodiments of the present invention deal with the problem of always guiding or keeping an agricultural attachment apparatus at an exact height or depth (for example, 5, 10 or 30 cm) during the initially mentioned work (cultivating, ploughing, sowing, harvesting, etc.) under a wide variety of conditions (changes in the ground profile, different ground conditions (for example, dry or wet ground), heterogeneous vegetation and vegetation density, field vegetation, etc.) without the driver of the towing vehicle or the harvesting machine having to intervene. In practice, the processing height or depth often varies due to the conditions mentioned above, which results, for example, in an inhomogeneous processing structure of the ground or a corresponding loss of harvest.

In practical tests, it has been found that a distance measuring system with ultrasonic sensors, as described in DE 10 2005 051 407 B4, is well suitable for the initially mentioned work, but, for example, in a stubble field with dense ground vegetation or heavy weed vegetation, the distance to the ground is not always detected reliably. The problem described in [0015] of the patent specification itself is disadvantageous in the device for measuring the ground distance according to DE 10 2005 051 407 B4: the more measuring values are included in smoothing, the more accurate the average value becomes, but the detail accuracy and thus the reaction speed of the ground distance measurement are reduced. With the described measuring principle, the real ground distance is virtually approximated by a measuring value iteration so that the measuring system reaches its limits in particular when there is high vegetation on the ground to be measured. Enlarging the target window or increasing the support values would not bring about an improvement, but rather impair the measurement accuracy.

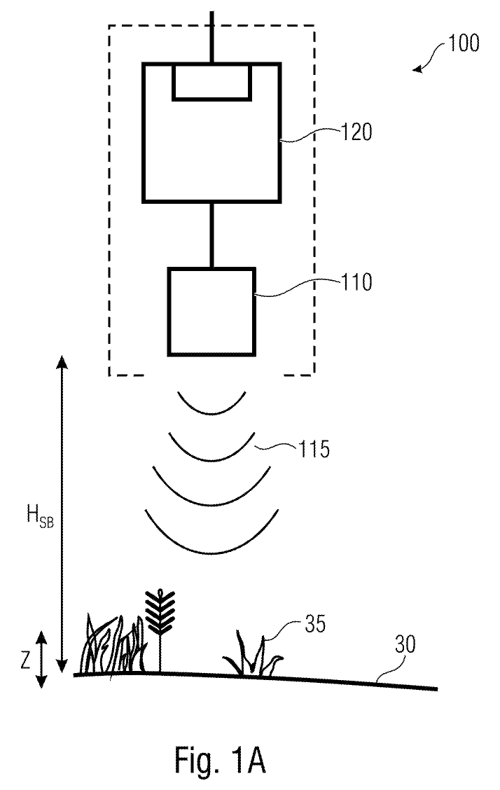

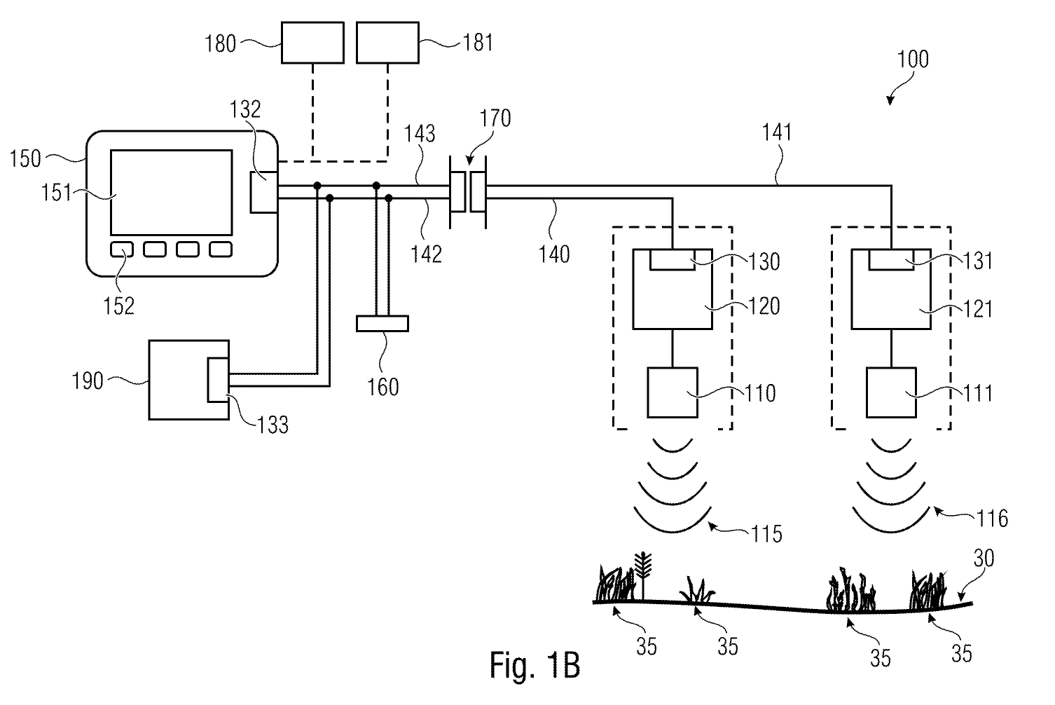

In order to achieve an appropriate precision of the measurement accuracy with a sufficiently short reaction time under the conditions mentioned above for a distance (or clearance) measuring system, a corresponding improvement is required. This is where the present invention starts:
A measuring system 100 comprising at least one distance sensor 110 and an evaluating unit 120, as shown in FIG. 1a. The distance sensor 110 may be, for example, a contactless distance sensor, e.g., based on ultrasound. It transmits the ultrasonic signals 115 in the direction of the ground 30 to be processed in order to determine the distance HSB between the ground 30 to be processed and the distance sensor 110. The (disturbing) vegetation 35 partially reflects the ultrasonic signal 115 so that incorrect measurements may occur.

The distance sensor signals determined by the distance sensor 110 are associated with distance values. These distance sensor signals or the determined distance values are transferred to the evaluating unit 120 which then performs an evaluation as follows in order to obtain validated distance values or at least one validated distance value. The evaluating unit 120, when determining the validated distance value, only takes into account that distance values lying within a predetermined window Z.

According to embodiments, the evaluating unit 120 is configured to take into account and/or to adopt only those distance values lying within a predetermined window Z as the one or more validated distance values, wherein the predetermined window Z is defined by an expectation value for the distance to the ground 30 and a positive and/or negative offset, so that the window Z specifies a range of values limited by the expectation value, and wherein distance values outside the predetermined window Z are not taken into account.

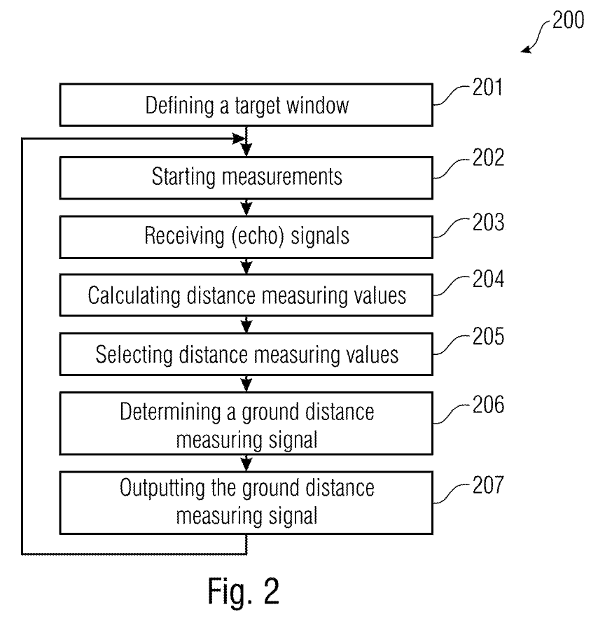

This window Z corresponds to the expectation value with a positive and/or negative offset in which the height of the ground 30 is expected to vary. Because Z is selected to be smaller than the height of the vegetation, the distance values which are measured with respect to the vegetation are not taken into account or discarded. With respect to the window Z, it is to be noted that it may be defined by an expectation horizon/range for the value H_{SB} and a positive and negative offset. The offset may vary symmetrically or also asymmetrically. According to embodiments, Z is defined in dependence on the ground type, the vegetation type (cf. step 201, in FIG. 2). This can be performed, for example, by the driver, i.e., based on a presetting.

A window Z is predetermined by an expectation value for the distance to the ground and a positive and/or negative offset, so that the window Z defines an expectation range (a range of values limited by the expectation value). A limited interval or limited window is defined by this. The offsets represent the limits of the interval, for example.

During the journey, the sensor 110 determines a plurality of distance values along the direction of travel F which are then associated with different positions. The positions can be determined, for example, with the aid of GNSS sensor technology. According to embodiments, several distance values may also be settled relative to one another, e.g., by averaging or moving averaging or average filtering.

Based on this basic principle, an extended embodiment with optional features is explained below. FIG. 1b schematically shows a distance measuring system 100 with a distance sensor 110 and an evaluating unit 120 connected thereto. Optionally, the measuring system 100 may also comprise a further distance sensor 111 with an associated evaluating unit 121. The evaluating units 120 and 121 can in this case either be separate components or form an integrated unit with the associated distance sensors 110 and 111.

According to the measuring method 200 shown in FIG. 2 with reference to FIG. 1b, each of the two sensors 110 and 111 transmits during operation if arranged on an agricultural attachment apparatus 40 according to the present invention its own ultrasonic signal 115 or 116 in the direction of a ground 30 to be processed (cf. 202-207) in order to measure a distance to the ground 30. The emitted signals 115, 116 are reflected both from the ground 30 and from (disturbing) vegetation 35 present on the ground and received again by the sensors 110, 111 (cf. 203). Distance values are calculated by the corresponding evaluating units 120, 121 from all the received (echo) signals and a respective ground distance measuring signal is determined (cf. 206). The determined ground distance measuring signals are output via the corresponding interface 130 or 131 and the cable connections 140 to 143 to, for example, height or depth regulation 190 for the attachment apparatus 40 (cf. 207).

As further shown in FIG. 1b, the distance measuring system 100 also comprises a display and operating unit 150, which is advantageously arranged in the driver's cab of a towing vehicle 10 such as, for example, a tractor or a self-propelled harvesting machine (not shown in FIG. 1a). The display and operating unit 150 comprises an interface 132 for transmitting and receiving data, such as, for example, the ground distance measuring signals described above, and a display 151 and keypads 152 for displaying and inputting or changing data, parameters, values, etc. For example, the ground distance measuring signals described above can be displayed visually on the display 151, target values and parameters for the height or depth regulation 190 can be set and changed or else an adaptation of the calculation algorithm can be carried out in the sensors 110, 111. The corresponding settings are transmitted from one component to the other via the interfaces 130 to 133, which are advantageously digital interfaces such as, for example, ISOBUS.

The distance measuring system 100 may also comprise a GNSS/GPS receiver 180 and a communication unit 181, which are electrically connected to, for example, the display and operating unit 150. With the aid of the GNSS/GPS receiver 180, for example, the position and a speed of the machine can be determined. Data, parameters or other values can be exchanged with a cloud server (not shown) or a mobile terminal (also not shown) via the communication unit 181, for example WLAN or Bluetooth. For example, weather or ground data can be input into the system and thus settings and parameters can be changed correspondingly in the evaluating units 120 and 121 or the height and depth regulation 190.

Reference numeral 160 shows a signal socket on the towing vehicle 10, via which, for example, impulses are output from which the speed can then be calculated. Furthermore, reference numeral 170 shows a plug-in connection via which that parts of the distance measuring system 100 associated with the attachment apparatus 40 (sensors and evaluating units) can be electrically separated from the remaining part on the machine 10 easily and quickly. As a result, for example, different attachment apparatuses 40 can be used or employed on the towing vehicle 10.

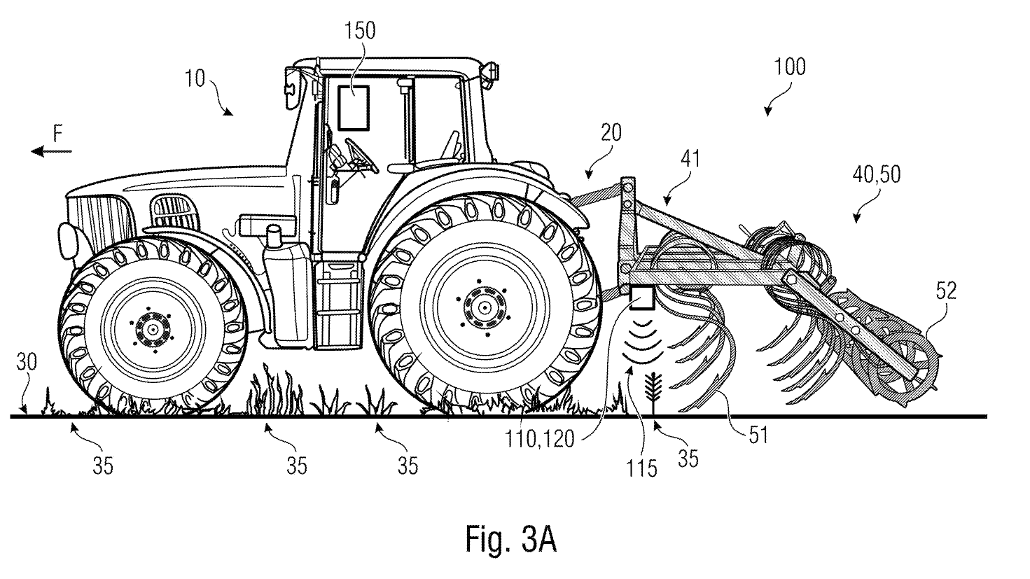

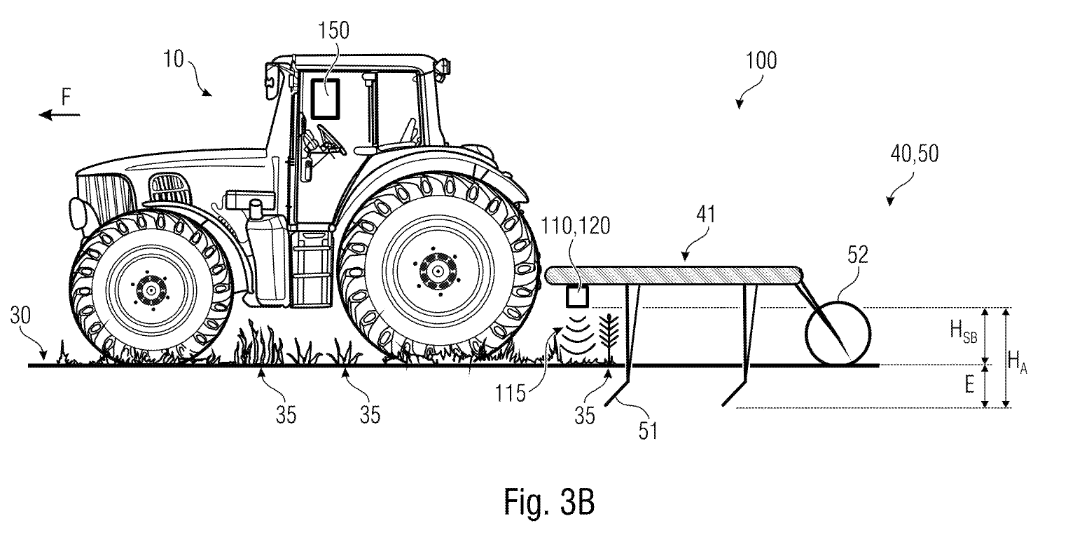

It is to be noted that the following FIGS. 3a/3b-6 and the descriptions thereof advantageously relate to a distance measuring system 100 having only one distance sensor 110 and one evaluating unit 120. Further distance sensors and further evaluating units are used in particular when the attachment apparatus 40 is to be held parallel to the ground, i.e., is to be held in balance in and/or transversely to the direction of travel F.

FIGS. 3a and 3b schematically show a tractor 10 as a towing vehicle with a cultivator 50 as an attachment apparatus 40. The cultivator 50 has a frame 41 which is mechanically and hydraulically connected to the tractor 10 via a three-point linkage 20. Spring prongs 51 and a crumb roller 52 are arranged on the frame 41 of the cultivator 50 for ground processing. The spring prongs 51 engage into the ground 30 to be processed during the ground processing for loosening or changing the ground to be processed. The cultivator 50 can be changed in its height position, i.e., raised or lowered, via the three-point linkage 20. A change in the height position thus brings about a change in an engagement depth E of the spring prongs 51 into the ground 30 to be processed.

In order to be able to perform uniform ground processing, a distance measuring system 100 as described in FIGS. 1 and 2 is arranged on the cultivator 50 and the tractor 10. The sensor 110 is arranged on the frame 41 of the cultivator 50 at an attaching height H_{A} and measures a distance H_{SB} from the ground 30 to be processed by means of ultrasound 115. The engagement depth E of the spring prongs 51 into the ground 30 to be processed thus results from the difference between the attaching height H_{A} and the distance H_{SB}. During the ground processing, the tractor 10 and the cultivator 50 move over the ground 30 to be processed, on which there is different (disturbing) vegetation 35, for example stubbles, weed or other vegetation. During the ground processing, the distance measuring system 100 continuously determines a ground distance measuring signal and supplies it to the subsequent depth regulation 190, which keeps or guides the cultivator 50 at a predefined engagement depth E during the work despite the presence of (disturbing) vegetation 35.

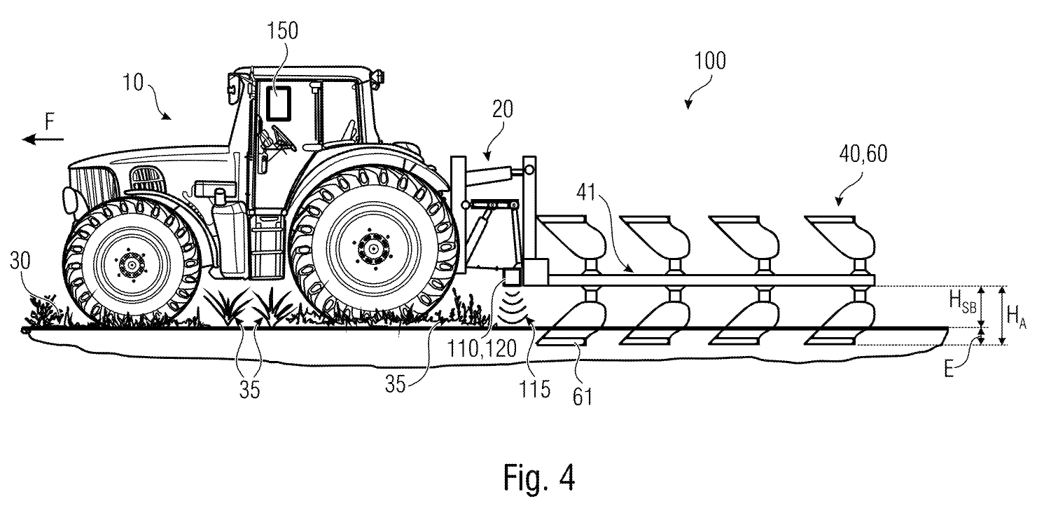

FIG. 4 schematically shows a tractor 10 as a towing vehicle with a plough 60 as an attachment apparatus 40. The plough 60 has a frame 41 which is mechanically and hydraulically connected to the tractor 10 via a three-point linkage 20. Plough shares 61 are arranged on the frame 41 of the plough 60 for soil or ground processing. The plough shares 61 engage into the ground 30 to be processed during the ground processing for breaking up the ground to be processed. The plough 60 can be changed in its height position, i.e. raised or lowered, via the three-point linkage 20. A change in the height position thus brings about a change in an engagement depth E of the plough shares 61 into the ground 30 to be processed.

In order to be able to perform uniform ground processing, a distance measuring system 100 as described in FIGS. 1 and 2 is arranged on the plough 60 and the tractor 10. The sensor 110 is arranged on the frame 41 of the plough 60 at an attaching height H_{A} and measures a distance H_{SB} from the ground 30 to be processed by means of ultrasound 115. The engagement depth E of the plough shares 61 into the ground 30 to be processed thus results from the difference between the attaching height H_{A} and the distance H_{SB}. During ground processing, the tractor 10 and the plough 60 move over the ground 30 to be processed, on which there is different (disturbing) vegetation 35, for example stubbles, weed or other vegetation. During ground processing, the distance measuring system 100 continuously determines a ground distance measuring signal and supplies it to the subsequent depth regulation 190, which keeps or guides the plough 60 at a predefined engagement depth E during the work despite the presence of (disturbing) vegetation 35.

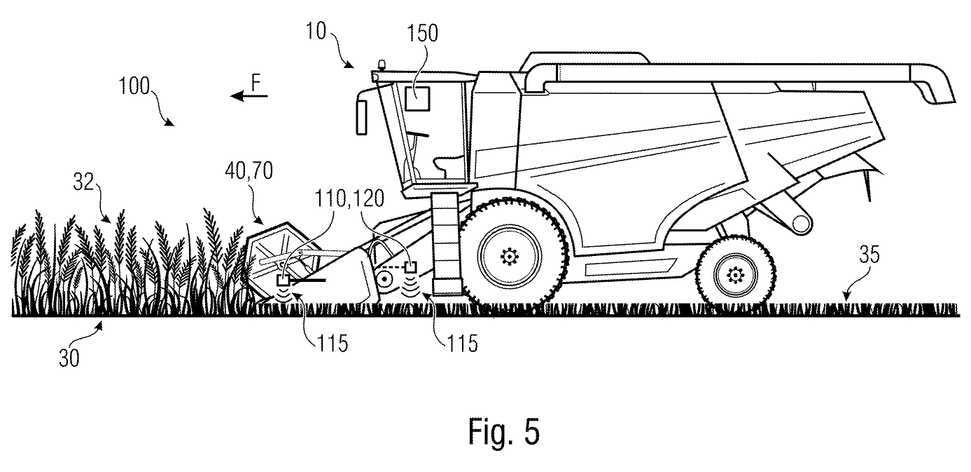

FIG. 5 schematically shows a self-propelled combine harvester 10 with a harvesting attachment 70 as an attachment apparatus 40. With the aid of the harvesting attachment 70, the combine harvester 10 can harvest, for example, a grain field 32. The grain stubbles 35 still standing then remain on the harvested ground 30.

The harvesting attachment 70 is mechanically and hydraulically connected to the combine harvester 10 and can be changed in its height position, i.e., raised or lowered. A change in the height position of the harvesting attachment 70 thus effects a change in the remaining stubble height above the ground 30 to be processed.

In order to be able to perform uniform harvesting of the grain 32, a distance measuring system 100 as described in FIGS. 1 and 2 is arranged on the harvesting attachment 70. The sensor 110 is arranged on the harvesting attachment 70 at an attaching height H_{A} and measures a distance H_{SB} from the ground 30 already harvested by means of ultrasound 115. The height of the harvesting attachment 70 to be set above the ground 30 to be processed or harvested thus results from the difference between the distance H_{SB} and the attaching height H_{A}. During ground processing (harvesting), the combine harvester 10 and the harvesting attachment 70 move over the ground 30 to be processed, on which, after harvesting the grain 32, predominantly stubbles 35 and possibly further (disturbing) vegetation such as weed or other vegetation remain. With such a combine harvester 10, legumes or the like could also be harvested using a corresponding harvesting attachment. During the harvesting operation, the distance measuring system 100 continuously determines a ground distance measuring signal and supplies it to the subsequent height regulation 190, which keeps or guides the harvesting attachment 70 at a predefined height during the work despite the presence of (disturbing) vegetation 35 (stubbles). In this context, the regulation of a transverse inclination is also conceivable, in particular in the case of very wide harvesting attachments 70.

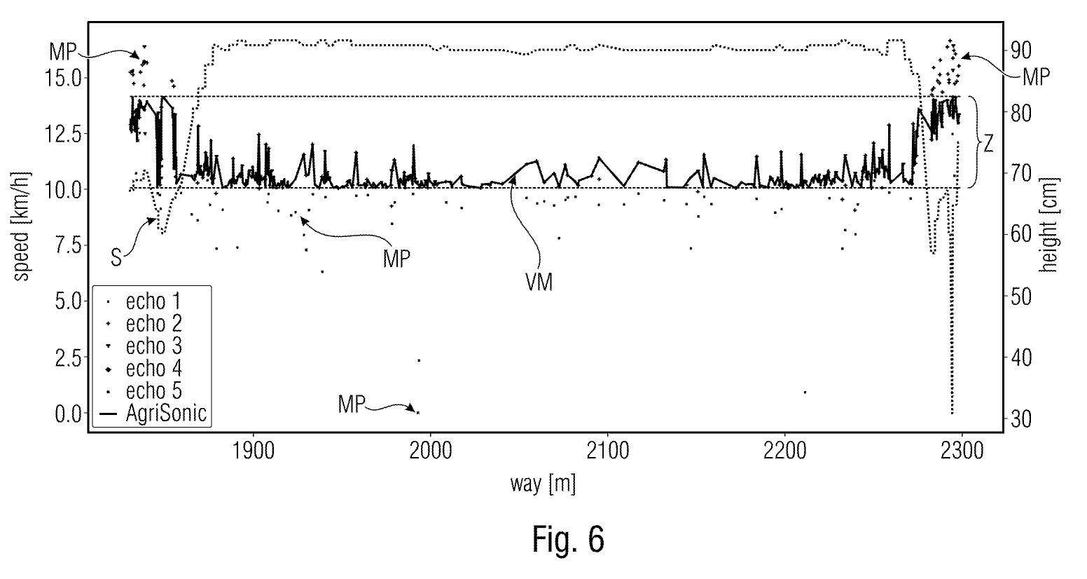

FIG. 6 shows the graphical waveform of distance measurements on a cultivator 50, with which a ground 30 (stubble field) was processed over a distance or way of approximately 480 m. The attaching height H_{A} of the sensor 110 is 75 cm. The range between the dashed lines represents the defined target window Z in the range of 68 cm to 82 cm (attaching height H_{A} +/−7 cm offset). The solid line S represents the travel speed of the tractor and of the attachment apparatus. The points denoted by MP represent measuring points of the ground 30 and of the vegetation 35, wherein the measuring points MP are represented with different symbols depending on the reflected (echo) signal. The measurements were evaluated in the evaluation unit 120 with the above-described first variation of the signal evaluation. That measuring values lying “furthest up” in the predefined target window Z from all the received (echo) signals, i.e. have the highest or greatest distance value, were connected by a line (line VM). Here, it can be assumed that these (echo) signals were reflected from the ground 30 and not from the vegetation 35 (stalks, plants, weed, stubbles, etc.).

In the embodiments explained above, it was assumed that each distance sensor determines one or more distance signals. The background for this is that the sensor emits a signal at one and the same position and, for example, several echo signals can come back. These several echo signals can be from one or more points on the ground so that several distance signals with different distance values are also obtained. The evaluating unit then selects the distance value or the distance values (if there are several) lying within the predetermined window Z in order to obtain a validated distance value. If there are several, of course, several validated distance values lying in the window Z can be obtained. According to embodiments, averaging between the several distance values can also take place. Conversely, this means that the distance values associated with the one or more distance signals lying outside the window are not adopted as a validated distance value.

According to a further consideration, several distance signals can also be present when the distance sensor measures relative to the ground at two different points in time, i.e., for example, at two different positions. Depending on the point on the ground, a different distance value is obtained. For example, a first distance value can be measured relative to the ground itself, while a second distance value is measured, for example, relative to a grass or a further object outside the predetermined window. This second value is not adopted as the validated distance value.

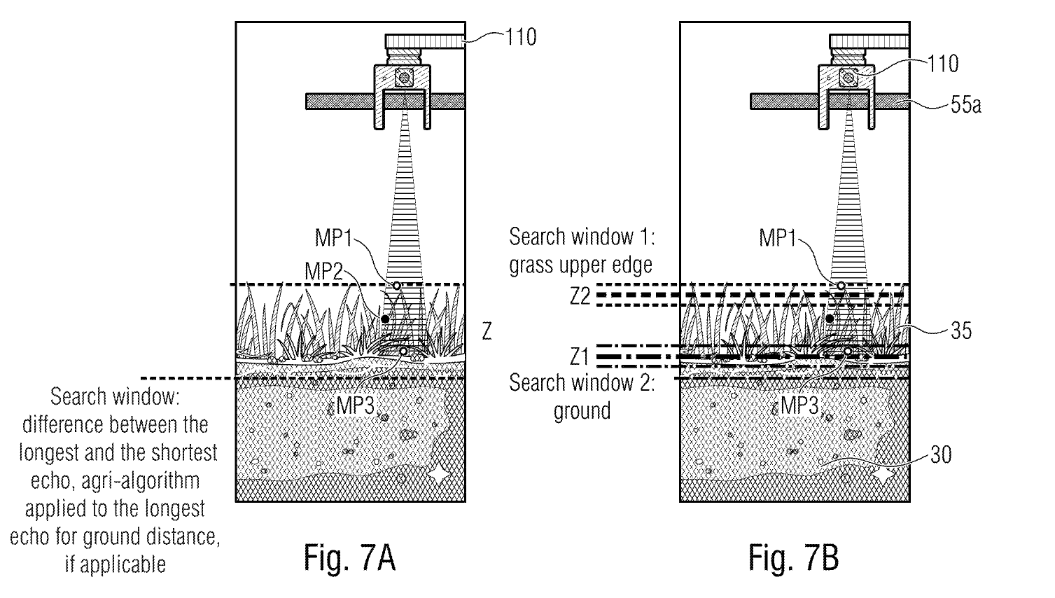

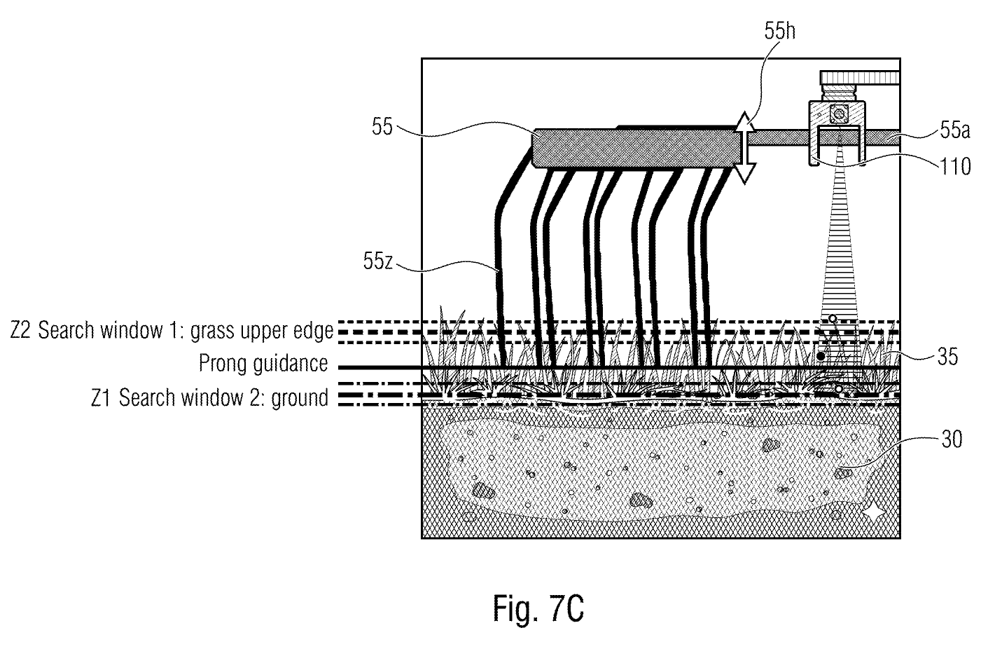

It will be explained below how the measurement principle explained above can be expanded to the extent that a plant height determination is possible. According to embodiments, the measurement system 100 is configured to determine, in addition to first validated distance values, also second validated distance values in a second predetermined window, wherein the first predetermined window Z1 lies, for example, in the region of the ground and the second predetermined window Z2, also referred to as further predetermined window, lies in the region of the plant tips. The predetermined windows Z1 and Z2 are illustrated in FIG. 7b, wherein the entire embodiment will now be explained making reference to FIGS. 7a and 7b.

FIG. 7a shows a distance sensor 110 which is positioned above the ground 30 on which plants 35 grow. These plants are located within the window Z so that several measuring points MP1, MP2 and MP3 can be determined. MP3 represents a measuring point in the region of the ground 30 and MP1 represents a measuring point in the region of the plant tip 35. In order to determine several measuring values, a so-called sonic ski plus (generally distance sensor) can be used in this application as well as in all other applications, which makes it possible to average the measuring values. The plant height can be determined on the basis of the difference between these two measuring points MP1 and MP3, as shown in FIG. 7b.

FIG. 7b shows the same arrangement as FIG. 7a, wherein two measuring windows Z1 and Z2 are set instead of the one measuring window Z. Z1 describes the measuring window in the region of the ground 30, while Z2 represents the measuring window in the region of the tip of the plants 35 (plant upper edge). The plant upper edge can be, for example, a grass upper edge for use in the height guidance of the rake prongs 55z of a rotary rake.

The core idea of this embodiment or aspect is to interpret the reflected echo signals with the measuring system 100 according to the invention with the sensor 110 such that a plant height and possibly the plant density can be derived therefrom. It is important to differentiate in a specific manner between the echo signals MP1 of plants 35 and the ground echo signals MP3 of the plants 30. Considering the amplitudes of the returning echo signals is also conceivable. Various approaches are conceivable:
The use of two windows Z1 and Z2 has already been explained referring to FIG. 7b. According to embodiments, the search windows Z1 and Z2 are set as follows: If, in addition to the ground 30 which is surrounded by a search window Z1, a further clear region Z2 is provided in which the plant upper edge of the plants 35 is located, these two search windows Z1 and Z2 can be evaluated separately and a difference therebetween can be determined, which results in the plant height.
According to further embodiments, a large search window Z, as illustrated in FIG. 7a, could also be used (enlargement of the search windows). The large search window extends, for example, from the ground 30 to the vegetation upper edge of the plants 35. According to this approach, the large search window Z is selected such that it contains both the ground 30 as well as the plant upper edge (cf. 35). Here, plants 35 with a smaller height are also recognized (cf. MP2). This approach would be suitable, for example, for the above-mentioned application of fertilizer. This means that the evaluating unit can be configured to evaluate a search window Z and to determine the minimum and maximum measured values MP1 and MP3 (comparison of echoes in the search window Z within a pulse).

According to further embodiments, a plant height can be determined by forming the difference between the minimum and maximum measured values MP1 and MP3. As an alternative to the minima (short echo) and maxima (long echo), an envelope curve evaluation can of course also take place. That is to say, the difference between the longest and shortest echo is formed (in the search window), possibly selecting the longest echo for ground distance.

Either the current algorithm is applied twice to two windows, Z1 and Z2, or as an alternative the envelope curve evaluation, as was explained in FIG. 7a.

According to embodiments, the following further points are to be taken into account when determining the plant height:

By means of a multiple echo evaluation and a specific evaluation algorithm, both ground echo signals as well as plant echo signals can be determined within a measurement and corresponding parameters, such as the plant height, can be calculated. Thus, in addition to the actual ground distance measurement, the plant height can also be determined in the same course. The benefit of the sensor or the measuring system is thus doubled.

FIG. 7c shows how a tool 55 of a rotary rake is varied in height such that the prongs 55Z of the tool 55 are positioned between the heights associated with the search windows Z1 and Z2. The height variation is illustrated by the reference numeral 55h. The rotary rake is only mentioned here as an example, since this height guidance can be used in all “engaging” elements (rake, turner, all machines with pick-up, etc.).

In detail, the above-explained measuring system (with the ultrasonic sensors) can be used in a system and a method for height control of components of agricultural devices, such as, for example, spray booms and mowing bars. The system calculates the distance to the upper edge of the cultivated plants 35 and to the ground 30 and adapts the device height 55h accordingly in order to ensure a predefined distance.

If, due to the high grass density, only the measured values MP1 to the second search window Z2 are visible, according to embodiments this can be assumed as the highest upper edge and, possibly, the height of the prong guidance for the prongs 55z can be adapted by using an offset. For a rake, for example, 2 cm below the grass upper edge are conceivable.

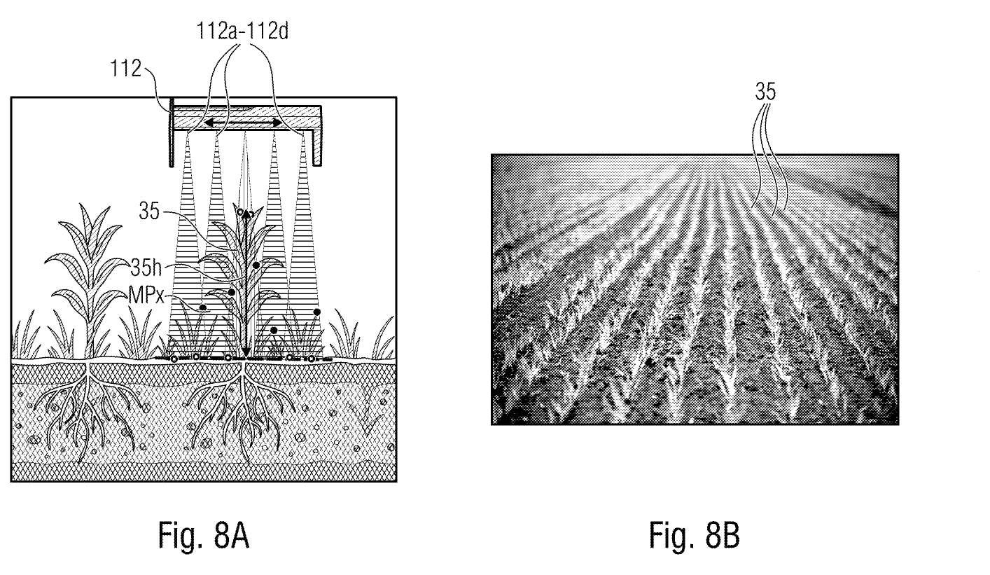

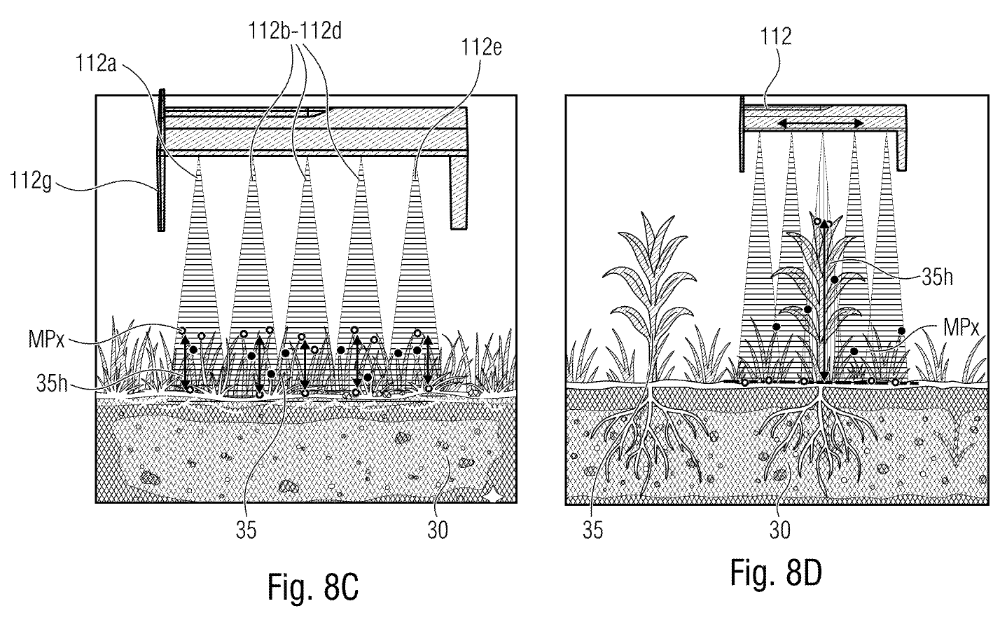

It will be explained on the basis of FIGS. 8a, 8b, 8c and 8d how the plant height 35h of the plant 35 can be determined by means of a distance sensor 112 which has several sensor heads 112a-e. The sensor heads 112a-e are arranged next to one another and aligned approximately equally. For example, as illustrated here, they may be located in a common housing 112g(cf. FIG. 8c). According to embodiments, scanning of five measuring ranges which are all arranged next to one another takes place by the sensor heads 112a-e. The corresponding emission cones are parallel to one another. As illustrated in FIG. 8a, a plant 35 and the region next to the plant 35 can be scanned by this. This is typical of a regularly and/or linearly arranged field, as illustrated in FIG. 8b. This results in the advantage of transverse guidance in row crops.

The ground 30 and the vegetation 35 arranged thereon are scanned by means of the sensor heads so that several measuring points MPx (cf. FIGS. 8c and 8d) are obtained.

According to embodiments, a lateral position of the plant 35 can be determined by the use of the sensor 112. As illustrated referring to FIG. 8b, the plants 35 are often arranged in rows so that the plant can be used as a reference. Thus, according to further embodiments, the measuring system is configured to determine a lateral position of a plant 35. According to further embodiments, the evaluating unit can determine a control signal on the basis of the position information which indicate the relative position of the plant 35 relative to the sensor. The control signal can be used, for example, to correct a direction of travel of the agricultural machine.

In the above embodiments, numerous agricultural applications have been explained, such as, for example, the use of the distance measuring system 100 on a combine harvester 10 or in connection with a tractor 10 as a towing vehicle, which, for example, pulls a plow 60 as an attachment apparatus. In addition, numerous other possibilities for the use of the described measuring system are also conceivable, such as, for example, the use in harvesting machines. These include: harvesting machines for crops, tubers, vegetables or root vegetables, such as, for example, carrots, parsnips, potatoes, onions, beets, sugar beet, lettuce, cabbage, etc. The harvesting of such fruits or vegetables takes place by special machines, for example with so-called full harvesters or harvesters, such as, for example, sieve chain harvesters or clamping belt harvesters. Thus, the harvested crop, such as, for example, carrots or potatoes, is taken up from the ground together with the soil, and separated from soil, herbs and stones. Lettuce or cabbage is cut off from the ground, for example, by machines on which height-adjustable blades are arranged, and loaded directly via conveyor belts. In all these machines, the measuring system 100 according to the invention according to embodiments can be used to ensure an exact depth or height guidance of the cutting or receiving devices.

Tests have shown that, for example, when harvesting of carrots, a vertical measurement of the distance to the ground or to the dam is difficult due to the herbs. An oblique arrangement of the sensor, where described above, would be possible or more useful here. Practically any scanning angles between 90° (vertical scanning on the ground) and 45° (oblique scanning on the ground) or also between 90° and 15° (lateral scanning) are conceivable here. A radar sensor for the distance measurement would also possibly be better suited here, since it can better measure through the herbs.

When harvesting vegetables or root vegetables, such as, for example, carrots or parsnips, a sonic ski sensor, i.e. a sensor arrangement (distance sensor/ultrasonic sensor) with several individual ultrasonic sensors arranged next to one another, could also be suitable for scanning the dam or the dam profile. Thus, the receiving device, which receives the harvested crop from the ground, could be guided in the lateral position. The sonic ski sensor suitable here has already been explained above.

Chopping machines for sugar beet or lettuce for mechanically removing weeds or harmful plants. In these machines, the measuring system 100 according to the invention according to embodiments can be used to set a so-called exact chopping depth.

Harvesting machines for legumes, such as, for example, soybeans, lentils, beans, peas, lupins, etc. The harvesting of legumes usually takes place with a combine harvester 10, which has already been explained in connection with FIG. 5.

Application of manure to the ground or to grassland. Application of manure close to the ground takes place with the help of towing hoses or towing shoes and is guided directly over the ground or the turf, usually at a height of only a few centimeters. The linkage with towing hoses is adapted to the unevenness of the ground so that the application height remains constant. Here, the measuring system 100 according to the invention can be used to ensure an exact height guidance.

According to embodiments, the use of the measuring system 100 according to the invention is also conceivable in non-agriculturally used machines or attachments, such as, for example, on snow ploughs for height guidance of the clearing blade. The measuring system 100 can be arranged on the clearing blade such that at least one distance sensor measures, for example, the already cleared region behind the clearing blade and thus ensures an exact height guidance of the clearing blade even in the case of uneven ground. If one distance sensor each is arranged at the lateral ends of the clearing blade, a transverse inclination of the ground can also be detected and, in addition to the height, the transverse position (transverse inclination) of the clearing blade can also be set or changed accordingly.

With reference to FIG. 7c, reference is made to the fact that the sensor 110 is, for example, arranged above a tool, here above the tool 55. The tool can be, for example, a rotating rake or hay turner.

Rotary rakes and hay turners are agricultural attachments, wherein the rotary rake is used for collecting hay or straw to form uniform swath and, in contrast, the hay turner distributes freshly cut mowed material, such as, for example, grass, uniformly on the turf for drying. These devices have one or more horizontally rotating rakes 55 with several prong arms 55a arranged in a star shape. Several rake prongs 55z, which graze vertically over the ground and transport or distribute the harvested crop to the side, are fastened to the prong arms.

Due to the rotation of the prong arms 55a, the measuring range of the sensor 110 is crossed at regular time intervals so that these measured values cannot be used for the measurement. Advantageously, these measured values lie outside the window Z (cf. FIG. 7a) or the windows Z1 and Z2 (as illustrated in FIGS. 7b and 7c) so that they are not taken into account for the subsequent evaluation.

In order to avoid that the rake prongs 55z either engage too deeply into the ground and thus contaminate the harvested crop with soil, or are guided too high so that harvested crop remains on the turf 35, a suitable height guidance of the rake prongs 55z is employed. The measuring system 100 according to the invention can be used for this. The idea here is to measure with the distance sensor 110 from above through the moving prong arms 55a of the rotary rake or hay turner, with the aim of recognizing the ground distance and possibly adjusting it. An arrangement of the distance sensor 110 above the turn ring or turntable in which the prong arms 55a are arranged is advantageous from a structural point of view. Mounting the sensor on the rotating turn ring/turntable or below the turn ring or turntable is difficult, since the chassis is located directly below the turn ring or the turntable, which makes a suitable arrangement of the distance sensor more difficult.

If the distance sensor 110 is measured from above through the moving prong arms 55a of the rotary rake or hay turner, a distance to one of the rotating prong arms takes place. Such a faulty measurement can, however, be recognized and calculated on the basis of the reflected echo signals, since the distance between the distance sensor and the prong arms is known.

To synchronize the distance measurement with the rotating prong arms of the rotary rake or hay turner, the measuring system can also comprise a position sensor, for example a Hall sensor or comparable inductive sensor, which detects the position of the prong arms. Such a sensor can, for example, be arranged in the region of the shaft of the turn ring of the rake. The signals of the position sensor are used to carry out a distance measurement only in the region between two prong arms so that no interfering echoes of the rotating prong arms influence a distance measurement. This means that, according to embodiments, the evaluating unit is configured to perform a synchronization in order to characterize the distance measurements not to be taken into account using a synchronization signal. According to embodiments, the evaluating device can obtain a sensor signal of a further sensor, such as a Hall sensor, for synchronization and time-align the corresponding sensor signals.

The measuring system according to the invention can also be used in loading wagons with pick-up roller or balers with pick-up roller, since it is also to be avoided here that the rake prongs of the pick-up roller either engage too deeply into the ground and thus contaminate the harvested crop with soil, or are guided too high so that harvested crop remains on the turf.

A rotary rake/hay turner is an agricultural processing device (haymaker, rotary rake, loading wagon with pick-up roller or baler with pick-up roller) which is used in forage harvesting. A sensor device (for example ultrasonic sensor) for measuring a stubble height and a device for changing the distance of the prong ends to the ground are provided.

Embodiments provide a measuring system 110, wherein the evaluating unit 120, 121 is configured to determine a plant height on the basis of the difference between the first and the second distance value. According to embodiments, the evaluating unit 120, 121 is configured to vary a height of a tool depending on the determined plant height.

Embodiments provide a measuring system 110, wherein the evaluating unit 120, 121 is configured to determine a lateral position of the first distance value relative to the second distance value. According to embodiments, the evaluating unit 120, 121 is configured to determine the lateral position of the agricultural machine 10 or of the agricultural attachment apparatus 40, 50, 60 on the basis of the lateral position and/or to derive a control signal for the agricultural machine 10 or the agricultural attachment apparatus 40, 50, 60 on the basis of the lateral position.

According to embodiments, the distance sensor 110, 111 has a plurality of sensor heads arranged next to one another and/or parallel to one another.

According to embodiments, the measuring system furthermore has several distance sensors 110, in particular distance sensors arranged transversely to the direction of travel F.

According to embodiments, the distance sensor 110, 111 is attached at an attachment height which corresponds to at least twice the growth height of a vegetation of the ground (30).

According to embodiments, the evaluating unit 120, 121 is connected to a man-machine interface 152, via which the type of the ground 30 and/or the vegetation of the ground 30 and/or the presetting can be defined.

According to embodiments, the measuring system furthermore has a GNSS sensor and/or a speed sensor and/or an interface for receiving position information or speed information.

Although some aspects have been described in connection with an apparatus, it is understood that these aspects also represent a description of the corresponding method so that a block or a component of an apparatus is also to be understood as a corresponding method step or feature of a method step. In analogy, aspects which have been described in connection with or as a method step also represent a description of a corresponding block or detail or feature of a corresponding apparatus. Some or all of the method steps may be performed by a hardware apparatus (or using a hardware apparatus), such as, for example, a microprocessor, a programmable computer or an electronic circuit. In some embodiments, some or several of the most important method steps may be performed by such an apparatus.

Depending on certain implementation requirements, embodiments of the invention may be implemented in hardware or in software. The implementation may be performed using a digital storage medium, for example a floppy disk, a DVD, Blu-ray disc, CD, ROM, PROM, an EPROM, EEPROM or FLASH memory, a hard disk or another magnetic or optical memory on which electronically readable control signals are stored which are able to cooperate or cooperate with a programmable computer system such that the respective method is performed. Therefore, the digital storage medium may be computer-readable.

Some embodiments according to the invention thus comprise a data carrier which has electronically readable control signals which are able to cooperate with a programmable computer system such that one of the methods described herein is performed.

In general, embodiments of the present invention may be implemented as a computer program product having a program code, wherein the program code is operative to perform any of the methods when the computer program product runs on a computer.

The program code may also be stored, for example, on a machine-readable carrier.

Other embodiments comprise the computer program for performing any of the methods described herein, wherein the computer program is stored on a machine-readable carrier. In other words, an embodiment of the method according to the invention is thus a computer program which has a program code for performing any of the methods described herein when the computer program runs on a computer.

A further embodiment of the methods according to the invention is thus a data carrier (or a digital storage medium or a computer-readable medium) on which the computer program for performing any of the methods described herein is recorded.

A further embodiment of the method according to the invention is thus a data stream or a sequence of signals which represents or represent the computer program for performing any of the methods described herein. The data stream or the sequence of signals may be configured, for example, to be transferred via a data communication connection, for example via the Internet.

A further embodiment comprises a processing device, for example a computer or a programmable logic device, which is configured or adapted to perform any of the methods described herein.

A further embodiment comprises a computer on which the computer program for performing any of the methods described herein is installed.

A further embodiment according to the invention comprises an apparatus or a system, configured to transmit a computer program for performing at least one of the methods described herein to a receiver. The transmission may take place, for example, electronically or optically. The receiver may be, for example, a computer, a mobile device, a memory device or a similar apparatus. The apparatus or the system may comprise, for example, a file server for transmitting the computer program to the receiver.

In some embodiments, a programmable logic device (for example a field-programmable gate array, FPGA) can be used to perform some or all of the functionalities of the methods described herein. In some embodiments, a field-programmable gate array may cooperate with a microprocessor to perform any of the methods described herein. Generally, in some embodiments, the methods are performed by any hardware apparatus. This may be universally usable hardware such as a computer processor (CPU) or hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A measuring system, in particular for an agricultural machine or for an agricultural attachment apparatus of an agricultural machine, comprising:
at least one distance sensor configured to detect a distance to a ground in a contactless manner and to output one or more distance signals, each indicating a distance value, in dependence on the distance;
and an evaluating unit configured to evaluate the distance value(s) in order to acquire one or more validated distance value,
wherein the evaluating unit only takes into account and/or adopts that distance value(s) lying within a predetermined window as the one or more validated distance value,
wherein the predetermined window is defined by an expectation value for the distance to the ground and a positive and/or negative offset so that the window defines or specifies an expectation range.

2. The measuring system according to claim 1, wherein the validated distance value represents a validated first distance value and wherein the evaluating unit is configured to evaluate the distance value(s) in order to determine a validated second distance value, wherein the evaluating unit, when determining the validated second distance value, only takes into account that distance value(s) lying within a further predetermined window.

3. The measuring system according to claim 1, wherein the evaluating unit is configured to evaluate the distance values in order to determine, starting from several validated distance values, a validated first distance value and a validated second distance value, wherein the evaluating unit takes into account that distance value(s) representing a minimum distance as the validated second distance value, and takes into account that distance value(s) representing a maximum distance as the validated first distance value.

4. The measuring system according to claim 2, wherein the evaluating unit is configured to determine a plant height on the basis of the difference between the first and the second distance value.

5. The measuring system according to claim 2, wherein the evaluating unit is configured to determine a lateral position of the first distance value relative to the second distance value.

6. The measuring system according to claim 1, wherein the distance sensor is arranged above the rotating tool, in particular the tool of a rotary rake or hay turner; and/or
wherein the tool is located temporarily in a field of view of the distance sensor.

7. The measuring system according to claim 1, wherein the evaluating unit is configured not to take into account distance values measured with respect to a rotating tool and/or not to take into account distance values acquired in a time window comprising a synchronization signal or a sensor signal, in particular a sensor signal of a Hall sensor.

8. The measuring system according to claim 1, wherein the predetermined window (and/or thus the offset) is defined in dependence on a presetting and/or a soil type of the ground and/or a vegetation of the ground; and/or
wherein the predetermined window comprises a width which corresponds to a range between 1% and 10% or between 1% and 20% or between 1% and 30% or between 5% and 30% of the attaching height of the distance sensor.

9. The measuring system according to claim 6, wherein the expectation value is defined by an initial reference value and/or an attaching height and/or a reference measurement; and/or.
wherein the expectation value is defined by the initial reference value and/or the attaching height and/or the reference measurement minus an engagement depth of the agricultural attachment apparatus or a determined engagement depth for the agricultural attachment apparatus.

10. The measuring system according to claim 1, wherein the evaluating unit is configured to discard distance values outside the predetermined window; and/or
wherein the evaluating unit is configured to discard distance values outside the predetermined window and instead to use distance values lying within the window or exhibiting a minimum difference to a previously determined distance value; and/or
wherein the evaluating unit is configured to determine the validated distance value based on a previously determined validated distance value if all the distance values lie outside the predetermined window.

11. The measuring system according to claim 1, wherein the distance sensor comprises an ultrasonic sensor and/or is configured to receive echo signals which are reflected from the ground and/or vegetation of the ground by an emitted measuring signal.

12. The measuring system according to claim 1, wherein the distance sensor is configured to perform a reference measurement for compensating temperature influences, air pressure influences, air humidity influences and/or for calibration.

13. The measuring system according to claim 1, wherein the evaluating unit is configured to adjust a filter setting depending on a type of the ground and/or a vegetation of the ground and/or a presetting and/or a travel speed of the agricultural machine.

14. The measuring system according to claim 1, wherein the evaluating unit is configured to vary a sampling rate and/or measuring period of the distance sensor in dependence on a type of the ground and/or vegetation of the ground and/or presetting and/or travel speed of the agricultural machine; and/or
wherein the evaluating unit is configured to adapt transmission or reception parameters of the distance sensor in dependence on a type of the ground and/or vegetation of the ground and/or presetting; and/or
wherein the evaluating unit is configured to activate or deactivate a mode for evaluating the amplitude of the distance signal in dependence on a type of the ground and/or vegetation of the ground and/or presetting.

15. The measuring system according to claim 1, wherein the evaluating unit is configured to perform average filtering over several distance signals and distance values associated with different positions and/or different points in time and/or to calculate a moving average; or
wherein the evaluating unit is configured to perform average filtering over several distance values within the window associated with different positions and/or different points in time and/or to calculate a moving average; and/or
wherein the evaluating unit is configured to perform several measurements at several successive positions and/or points in time in the direction of travel.

16. The measuring system according to claim 1, further connected to a controller which is configured to control and/or to keep constant a height and/or depth of an agricultural attachment apparatus of the agricultural machine based on the validated distance value; and/or
further connected to a controller which is configured to control and/or to keep constant a transverse inclination based on a validated distance value.

17. An agricultural machine, in particular an agricultural machine comprising an agricultural attachment apparatus, such as, for example, a cultivator, a harrow, a plough, a soil tiller, a seeding or drilling machine, a harvesting machine, a rotary rake or a hay turner, a cutting or mowing mechanism, comprising a measuring system according to claim 1.

18. The agricultural machine according to claim 17, wherein the agricultural machine further comprises a controller configured to control and/or to keep constant a height and/or depth of the agricultural attachment apparatus of the agricultural machine based on a validated distance value.

19. A method for performing a measurement using a measuring system for an agricultural machine or an agricultural attachment apparatus, wherein the measuring system comprises at least one distance sensor configured to detect a distance to a ground in a contactless manner and to output one or more distance signals, each indicating a distance value, in dependence on the distance, comprising:
evaluating the distance value(s) in order to acquire one or more validated distance value, wherein, when determining the validated distance value, only that distance value(s) lying within a predetermined window are taken into account and/or adopted, wherein the predetermined window is defined by an expectation value for the distance to the ground and a positive and/or negative offset so that the window defines or specifies an expectation range.

20. A non-transitory digital computer-readable medium having stored thereon a computer program for performing a method for performing a measurement using a measuring system for an agricultural machine or an agricultural attachment apparatus, wherein the measuring system comprises at least one distance sensor configured to detect a distance to a ground in a contactless manner and to output one or more distance signals, each indicating a distance value, in dependence on the distance, comprising:
evaluating the distance value(s) in order to acquire one or more validated distance value, wherein, when determining the validated distance value, only that distance value(s) lying within a predetermined window are taken into account and/or adopted, wherein the predetermined window is defined by an expectation value for the distance to the ground and a positive and/or negative offset so that the window defines or specifies an expectation range,
when the computer program is run by a computer.
